(19) United States
(12) Patent Application Publication
(10) Pub. No.: US 2012/0152837 A1
(43) Pub. Date: Jun. 21, 2012

(54) BIOLOGICAL TREATMENT METHOD OF ORGANIC-MATTER-CONTAINING WATER

(75) Inventors: Yu Tanaka, Tokyo (JP); Minoru Watanabe, Tokyo (JP)

(73) Assignee: KURITA WATER INDUSTRIES LTD., Tokyo (JP)

(21) Appl. No.: 13/393,274

(22) PCT Filed: Sep. 29, 2009
(86) PCT No.: PCT/JP2009/066903

§ 371 Date: Feb. 29, 2012

(51) Int. Cl. C02F 3/12; C02F 1/44

(52) U.S. Cl. 210/631

(57) ABSTRACT

Provided is a biological treatment method of organic-matter-containing water in which a decrease in the permeation flux of a membrane in a membrane-separation activated-sludge process can be effectively suppressed. A biological treatment method of organic-matter-containing water includes introducing organic-matter-containing water containing organic matter into a biological treatment tank, mixing the organic-matter-containing water with activated sludge, biologically treating the organic-matter-containing water, and subjecting a mixed liquor of the organic-matter-containing water and the activated sludge to membrane separation, wherein an iron salt and a phenolic resin are added to the raw water. Substances (for example, metabolites of activated-sludge organisms) that cause a decrease in the permeation flux of a separation membrane become insoluble due to the flocculating effect by the iron salt and bonding with the phenolic resin.

### FIELD OF INVENTION

The present invention relates to a biological treatment method of organic-matter-containing water in which organic-matter-containing water is treated by an activated-sludge process, in particular, to a biological treatment method in which a biologically treated solution is directly subjected to membrane separation to provide treated water.

### BACKGROUND OF INVENTION

A method for obtaining treated water by subjecting an activated-sludge mixed liquor in a biological treatment tank to solid-liquid separation employs membrane separation for the solid-liquid separation (for example, Patent Documents 1 to 3 below).

In a membrane-separation device installed in a membrane-separation activated-sludge process, the membrane tends to be clogged because microorganisms, viscous substances produced by microorganisms, and the like in an activated-sludge mixed liquor adhere to the membrane surface.

For this reason, the mixed liquor suspended solid in a biological treatment tank may be maintained to be low (for example, 10,000 mg/L or less) so that a BOD (organic matter represented by biochemical oxygen demand) sludge load with respect to sludge held in the biological treatment tank is suppressed to about 0.1 kg-BOD/kg-MLVSS/day. However, a decrease in the mixed liquor suspended solid results in a decrease in the biological treatment efficiency. In addition, even when the mixed liquor suspended solid is thus decreased, the clogging of a membrane is not necessarily prevented; the permeation flux of a submerged membrane is about 0.5 m/day, and about 0.7 m/day at the highest.

To suppress such a decrease in the permeation flux of a membrane due to biological metabolites and the like in the membrane-separation activated-sludge process, a polymeric flocculant is added to the tank in Patent Document 1; an inorganic or organic flocculant is added in Patent Document 2; and a cationic polymer, an amphoteric polymer, or a zwitterionic polymer is added in Patent Document 3.

The applicant of the subject application proposed a method in which an iron salt is added to raw water and a biologically treated solution to be separated with a membrane is made to have a pH of 5 to 6.5 (Patent Document 4).
Patent Document 1: Japanese Patent Publication 8-332483
Patent Document 2: Japanese Patent Publication 2005-74345
Patent Document 3: Japanese Patent Publication 2006-334587
Patent Document 4: Japanese Patent Publication 2008-200639

### SUMMARY OF INVENTION

An object of the present invention is to provide a biological treatment method of organic-matter-containing water in which a decrease in the permeation flux of a membrane in the membrane-separation activated-sludge process can be further effectively suppressed, compared with existing methods.

A first embodiment is a biological treatment method of organic-matter-containing water, including introducing raw water containing organic-matter into a biological treatment tank, mixing the raw water with activated sludge, biologically treating the raw water, and subjecting a biologically treated solution to membrane separation, wherein an iron salt and a phenolic resin are added to the raw water or the biological treatment tank.

A second embodiment is the biological treatment method of organic-matter-containing water according to the first embodiment, wherein an Fe amount of the iron salt added is 0.2 to 1.0 times BOD flowing into the biological treatment tank in terms of weight.

A third embodiment is the biological treatment method of organic-matter-containing water according to the first or second embodiment, wherein an amount of the phenolic resin added is 1 to 500 mg/L with respect to the raw water.

A fourth embodiment is the biological treatment method of organic-matter-containing water according to any one of the first to third embodiments, wherein the phenolic resin has a molecular weight of 1,000 to 100,000.

A fifth embodiment is the biological treatment method of organic-matter-containing water according to any one of the first to fourth embodiments, wherein an amount of the phenolic resin added is 0.1 to 5.0 times an Fe amount of the iron salt added in terms of weight.

A sixth embodiment is the biological treatment method of organic-matter-containing water according to any one of the first to fifth embodiments, wherein the phenolic resin is added after being dissolved in an alkaline agent.

A seventh embodiment is the biological treatment method of organic-matter-containing water according to the sixth embodiment, wherein the phenolic resin is added in a form of an alkaline aqueous solution in which a concentration of the alkaline agent is 1 to 25 wt % and a concentration of the phenolic resin is 1 to 50 wt %.

An eighth embodiment is the biological treatment method of organic-matter-containing water according to any one of the first to seventh embodiments, wherein a load in the biological treatment tank is 0.5 to 5.0 kg-BOD/m³/day.

A ninth embodiment is the biological treatment method of organic-matter-containing water according to any one of the first to eighth embodiments, wherein the biologically treated solution is directly subjected to membrane separation.

In a biological treatment method of organic-matter-containing water according to the present invention, organic-matter-containing water is biologically treated with activated sludge in a biological treatment tank and subjected to solid-liquid separation with a membrane to provide treated water. In the present invention, an iron salt and a phenolic resin are added to the raw water or the biological treatment tank to thereby suppress a decrease in the permeation flux of the membrane.

The reason why the addition of the iron salt and the phenolic resin to the raw water or the biological treatment tank suppresses a decrease in the permeation flux of the membrane is not necessarily clear. However, the reason is probably that substances (for example, metabolites of activated-sludge organisms) that cause a decrease in the permeation flux of the separation membrane become insoluble due to the flocculating effect by the iron salt and bonding with the phenolic resin.

The iron salt and the phenolic resin are used in combination in the present invention. Accordingly, even when the amount of the iron salt added is made smaller than that in the case where the iron salt only is added, a decrease in the permeation flux of the membrane can be sufficiently suppressed. In addition, a decrease in the amount of the iron salt added results in a decrease in the amount of iron hydroxide sludge generated.

In summary, according to the above-described method of Patent Document 4, the effect of suppressing clogging of a membrane is sufficiently exhibited; however, a predetermined amount of an iron salt needs to be added with respect to the mixed liquor suspended solid. Accordingly, when the concentration of BOD flowing into a biological treatment tank is high, a large amount of the iron salt is required. The addition of a large amount of the iron salt results in an increase in the amount of sludge generated.

According to the present invention, the addition of an iron salt together with a phenolic resin results in a decrease in the required amount of the iron salt added and further enhancement of the filterability of the membrane. Therefore, an increase in the amount of sludge generated is suppressed and the treatment can be efficiently performed.

### BRIEF DESCRIPTION OF DRAWINGS

FIG. 1 is a flow diagram illustrating an example of a biological treatment apparatus used in the present invention.

FIG. 2 is a flow diagram illustrating another example of a biological treatment apparatus used in the present invention.

### DETAILED DESCRIPTION

Hereinafter, a biological treatment method of organic-matter-containing water according to an embodiment of the present invention will be described in detail.

The present invention includes introducing raw water composed of organic-matter-containing water into a biological treatment tank, biologically treating the raw water with activated sludge, and subjecting the biologically treated water to membrane separation, wherein an iron salt and a phenolic resin are added to the raw water or the biological treatment tank. The iron salt and the phenolic resin may be added to each of the raw water and the biological treatment tank; or the iron salt may be added to one of the raw water and the biological treatment tank and the phenolic resin may be added to the other.

The organic-matter-containing water treated by the present invention is not particularly limited. In particular, the present invention is suitably applicable to cases where natural water such as ground water, river water, or lake (including dam lake) water, tap water, or recycled water obtained by treating wastewater is treated as raw water and the resultant treated water is used to produce pure water.

These waters themselves have a low organic-matter concentration of about 0.1 to 100 mg/L. When the waters are used to produce pure water, the waters are biologically treated with, for example, biological activated carbon mainly containing microorganisms that are called oligotrophic bacteria including pseudomonas, and subsequently subjected to solid-liquid separation with, for example, an ultrafiltration (UF) membrane or a membrane having a pore size of about 0.2 μM or less. Membranes used for treating water for producing pure water have a small pore size and hence tend to become clogged. In particular, natural water may contain humin that tend to cause clogging of membranes and may have a high suspended solids (SS) concentration. The present invention provides a high capability of suppressing fouling and hence raw water may contain humin at a high concentration of more than 1 mg/L and may also contain SS in the range of about 0.1 to 30 mg/L.

The biological treatment tank for biologically treating such an organic-matter-containing water may be an aeration tank configured to remove BOD, a nitrification tank mainly configured to perform nitrification, a denitrification tank mainly configured to perform denitrification, or the like. The activated sludge may be a sludge mainly containing aerobic bacteria that decompose BOD (hereafter, particularly referred to as “BOD sludge”), a sludge mainly containing nitrifying bacteria that oxidize ammonia (hereafter, particularly referred to as “nitrifying sludge”), or a sludge mainly containing denitrifying bacteria that reduce nitric acid or nitrous acid (hereafter, particularly referred to as “denitrifying sludge”).

When the MLSS concentration in the biological treatment tank is made to be a high concentration of 2,000 to 50,000 mg/L, in particular, 5,000 to 20,000 mg/L, the biological treatment efficiency can be increased.

The ratio of the amount of organic matter to MLSS, specifically, an MLVSS (mixed liquor volatile suspended solids)/MLSS ratio is preferably in the range of about 0.1 to 0.9, in particular, 0.2 to 0.7. When the organic-matter concentration of organic-matter-containing water introduced into the biological treatment tank is excessively low (for example, the concentration of AOC (assimirable organic carbon), which is a biodegradable organic matter, is less than about 100 ng/L), the growth rate of activated sludge in the biological treatment tank decreases and the MLVSS/MLSS ratio may become out of the range. In such a case, a small amount of organic matter may be added to the biological treatment tank or another organic-matter-containing water having a high organic-matter concentration may be added to the biological treatment tank.

A carrier may be suspended in the biological treatment tank. Examples of such a suspended carrier include sponge and gel. The BOD load in the biological treatment tank is preferably 0.5 to 5.0 kg-BOD/day, in particular, about 0.5 to 2.0 kg-BOD/day.

According to the present invention, to suppress a decrease in the permeation flux of a separation membrane for obtaining treated water through solid-liquid separation of biologically treated water in the biological treatment tank, an iron salt and a phenolic resin are added to the raw water or the biological treatment tank.

The iron salt is not particularly limited and examples thereof include ferric chloride, ferrous chloride, and polyferric sulfate. These examples may be used alone or in combination of two or more thereof. The iron salt is preferably added in the form of an aqueous solution having a concentration of about 0.5 to 5.0 wt %.

The iron salt is preferably added such that the weight ratio of Fe to the inflow BOD is 0.2 to 1.0, in particular, 0.2 to 0.5. Although the amount of iron salt added varies depending on the quality of raw water, it is preferably about 0.1 to 200 mg-Fe/L with respect to raw water.

The phenolic resin added to raw water or the biological treatment tank may be a phenolic resin that is a condensate between a phenol such as a monohydric phenol (e.g., phenol, cresol, or xylenol) and an aldehyde such as formaldehyde or a modified product of the condensate and that is to be cured by crosslinking. Specific examples are as follows.

i) condensate between phenol and formaldehyde
ii) condensate between cresol and formaldehyde
iii) condensate between xylenol and formaldehyde
iv) alkyl-modified phenolic resins obtained by alkylating the phenolic resins i) to iii)

Such a phenolic resin may be a novolac-type resin, a resol-type resin, or a mixture of a novolac-type resin and a resol-type resin. Of the phenolic resins, a phenolic resin that is effective is selected and used in accordance with the type of the raw water.

Preferred examples of the novolac-type phenolic resin and the resol-type phenolic resin are represented by general formulae (I) and (II) below. These resins preferably have a molecular weight of 1,000 to 100,000, in particular, 1,000 to 50,000. Specifically, the general formula (I) below preferably represents a novolac-type phenolic resin where n is 1 to 500 and m is 1 to 500; the general formula (II) below preferably represents a resol-type phenolic resin where r is 10 to 500. Phenolic resins having an excessively high molecular weight may cause clogging of membranes; and phenolic resins having an excessively low molecular weight may leak through membranes.

### [Chem. 1]

### <Novolac-Type Phenolic Resin>

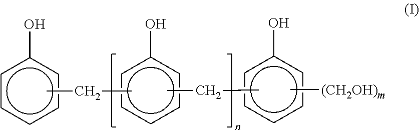

### <Resol-Type Phenolic Resin>

Since such a phenolic resin is slightly soluble in water, for example, the phenolic resin is preferably dissolved or dispersed in a water-soluble solvent and used in the form of a

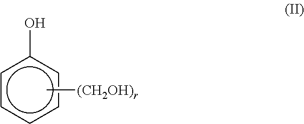

solution or an emulsion. Examples of the solvent include ketones such as acetone, esters such as methyl acetate, water-soluble organic solvents such as alcohols (e.g. methanol), alkaline aqueous solutions, and amines. The phenolic resin is preferably dissolved in an alkaline agent such as caustic soda (NaOH) or caustic potash (KOH).

When the phenolic resin is used in the form of an alkaline aqueous solution, the alkaline aqueous solution preferably has an alkaline-agent concentration of 1 to 25 wt % and a phenolic-resin concentration of 1 to 50 wt %. When the phenolic-resin concentration is high, the alkaline aqueous solution may be heated to about 70° C. to 80° C. so that the phenolic resin is dissolved.

Although the amount of the phenolic resin added to raw water or the biological treatment tank varies depending on the quality of the raw water, it is preferably 1 to 500 mg/L, in particular, 5 to 100 mg/L. The phenolic resin is preferably added such that the weight ratio of the phenolic resin to the inflow BOD is 0.1 to 2.0, in particular, 0.1 to 1.0. The phenolic resin is preferably added in an amount of 0.1 to 2.0 times, in particular, 0.2 to 1.0 times the Fe amount of the iron salt added in terms of weight.

When the amounts of the iron salt and the phenolic resin added are excessively low, the effect of suppressing clogging of membranes according to the present invention is not sufficiently exhibited; and when the amounts are excessively high, the amount of sludge generated increases and the treatment costs increase, which is not preferable. To provide an excellent synergistic effect due to the combined use of the iron salt and the phenolic resin, the ratio between the amounts of the iron salt and the phenolic resin added preferably satisfies the above-described ranges.

In the present invention, the tank solution to which the iron salt and the phenolic resin have been added (that is, a mixed liquor) in the biological treatment tank holding activated sludge preferably has a pH of 4.5 to 6.5, in particular, 5.0 to 6.5. The pH may be adjusted with an acid such as hydrochloric acid or an alkali. Alternatively, the pH may be adjusted without extra addition of an acid or an alkali depending on the type or amount of the iron salt added or the above-described alkaline aqueous solution for adding the phenolic resin. The alkali is preferably a soda alkali such as caustic soda rather than hydrated lime to suppress generation of scales.

By adding the iron salt and the phenolic resin, viscous metabolites and the like generated from activated sludge become insoluble due to the flocculating effect by the iron salt and the effect of bonding with the phenolic resin. As a result, a decrease in the permeation flux of the separation membrane is probably suppressed.

The separation membrane may be an MF (microfiltration) membrane, a UF (ultrafiltration) membrane, an NF (nanofiltration) membrane, or the like. The membrane may have a form of a plate and frame membrane, a tubular membrane, a hollow fiber, or the like. Non-limiting examples of the material of the membrane include PVDF (polyvinylidene fluoride), PE (polyethylene), and PP (polypropylene). The separation membrane may be disposed so as to be submerged in the biological treatment tank or may be disposed as a pressure membrane-separation device that is separate from the biological treatment tank. The submerged membrane is more preferable because flocs are less likely to be broken.

A portion of the solid content (separated sludge) having been separated from the liquid content through membrane separation may be optionally returned as return sludge to the biological treatment tank. The sludge is preferably extracted such that the sludge retention time in the biological treatment tank is about 2 to 50 days, in particular, about 5 to 20 days. The extracted sludge may be discharged as excess sludge or may be reduced in volume by volume reduction means such as an ozone reaction tank or a digester.

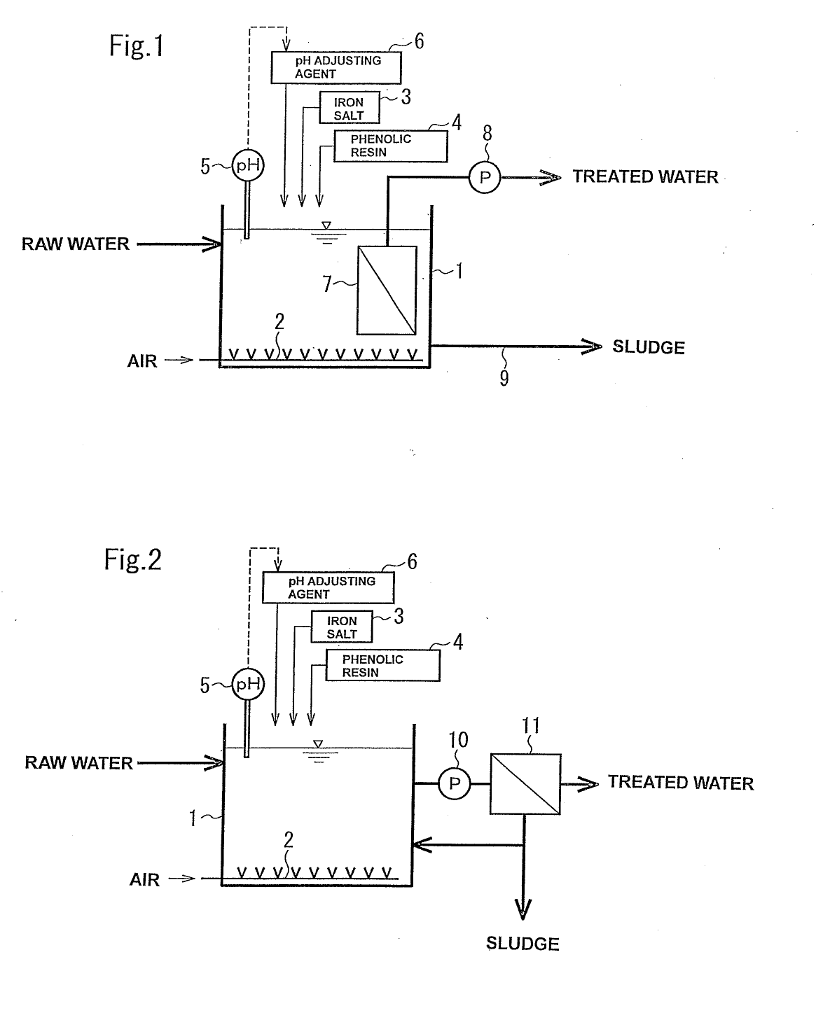

FIG. 1 is a flow diagram illustrating an example of a biological treatment apparatus for organic-matter-containing water used in the present invention (hereafter, simply referred to as “treatment apparatus”). Raw water is introduced into a biological treatment tank 1, mixed with activated sludge, and biologically treated. Aeration is performed with the air from a diffuser tube 2 disposed in a bottom portion of the biological treatment tank 1.

An aqueous solution of an iron salt is added to the biological treatment tank 1 by iron-salt addition means 3. A phenolic resin, preferably, an alkaline aqueous solution of a phenolic resin is added to the biological treatment tank 1 by phenolic-resin addition means 4. A pH adjusting agent such as an acid or an alkali is added by addition means 6 thereof such that the pH measured with a pH meter 5 is in a predetermined range. The iron salt or the phenolic resin may be added to the raw water. The biologically treated water is made to permeate a separation membrane 7 and extracted as treated water. Although the permeated water is extracted with a pump 8 in FIG. 1, the permeated water may be extracted by gravity.

The excess sludge in the biological treatment tank 1 is extracted through an extraction tube 9. A portion of the extracted sludge may be solubilized with ozone or the like and then returned to the biological treatment tank 1.

The separation membrane 7 is disposed so as to be submerged in the biological treatment tank 1 in FIG. 1. Alternatively, as illustrated in FIG. 2, the biologically treated water in the biological treatment tank 1 may be passed through a pressure membrane-separation device 11 with a pump 10; the permeated water is extracted as treated water; and a portion of (or the entirety of) the concentrated water may be returned to the biological treatment tank 1.

Non-limiting examples of the type of the membrane used in the membrane-separation device 11 include an MF membrane and a UF membrane. Non-limiting examples of the form of the membrane module used in the membrane-separation device 11 include a hollow-fiber membrane, a plate and frame membrane, and a spiral wound membrane.

In the case of FIG. 2, a portion of the concentrated water may also be introduced into a sludge solubilization tank, solubilized with ozone or the like, and then returned to the biological treatment tank 1.

The submerged separation membrane 7 illustrated in FIG. 1 is preferably used because flocs are less likely to be broken, compared with the pressure membrane-separation device 11 in FIG. 2.

According to the present invention, a decrease in the permeation flux of a membrane can be thus effectively suppressed in a biological treatment method of organic-matter-containing water in which a biologically treated solution is subjected to solid-liquid separation through direct membrane separation, in particular, in a biological treatment method of organic-matter-containing water in which a biologically treated solution is subjected to membrane separation with a submerged membrane module submerged in a biological treatment tank.

### EXAMPLES

Hereinafter, Example and Comparative examples will be described.

The raw water used in Example and Comparative examples below was organic wastewater having a BOD concentration of 50 mg/L.

An apparatus including submerged separation membranes in FIG. 1 was used. The volume of the biological treatment tank was 0.5 m³. The submerged separation membranes were three hollow-fiber MF membranes (MITSUBISHI RAYON CO., LTD., pore size: 0.4 μm) each having an area of 3 m².

For convenience of explanation, Comparative examples will be first described.

### Comparative Example 1

The raw-water flow rate was 10 m³/day. The BOD load was 1.0 kg-BOD/m³/day. Treated water (permeated water) was extracted through a treated-water pipe connected to the submerged separation membranes by reducing the pressure with a vacuum pump disposed at an intermediate position of the treated-water pipe.

As a result, it became impossible to extract the treated water due to clogging of the membranes after the lapse of three days from the initiation of the experiment. At this time, the TOC concentration of the treated water was 3.5 mg/L and the mixed liquor in the tank had the following properties.

MLSS concentration; 7000 mg/L (Fe content with respect to MLSS was 4.7 wt %)

MLVSS concentration; 4900 mg/L pH; 6.8

### Comparative Example 2

The biological treatment tank from which the treated water was no longer able to be extracted in Comparative example 1 was emptied. Activated sludge was added to the biological treatment tank such that the MLSS concentration became 5000 mg/L. A 0.5 wt % aqueous solution of ferric chloride was added to this mixed liquor such that a proportion of 1000 mg-Fe/L in terms of Fe was satisfied. A pH meter was disposed in the biological treatment tank and the pH was adjusted with sodium hydroxide such that a pH of 5.5 was maintained. The organic wastewater for treatment in Comparative example 1 was supplied to the biological treatment tank at a flow rate of 10 m³/day. Ferric chloride was added at a proportion of 25 mg-Fe/L with respect to the water inflow (the amount of Fe was 0.5 times the BOD load in terms of weight) to the biological treatment tank. An increase in the differential pressure of the submerged separation membranes became small after the lapse of three days from the initiation of supply of the water. The operation was stably continued at a permeation flux of 1.0 m/day for a month. The increase in the differential pressure after the lapse of one month was 20 kPa. At this time, the TOC concentration of the treated water was 2.3 mg/L and the mixed liquor in the biological treatment tank had the following properties.

MLSS concentration; 6500 mg/L (Fe content with respect to MLSS was 35 wt %)

MLVSS concentration; 3000 mg/L pH; 5.5

### Example 1

Following Comparative example 2, a 0.5 wt % aqueous solution of ferric chloride was added to the biological treatment tank so as to satisfy 10 mg-Fe/L with respect to the water inflow and a resol-type phenolic resin (manufactured by Gun Ei Chemical Industry Co., Ltd., molecular weight: 8000, r=80 in the general formula (II)) was added to the biological treatment tank so as to satisfy 25 mg/L with respect to the water inflow. The phenolic resin was added in the form of an alkaline aqueous solution in which the concentration of the phenolic resin was 0.1 wt % and the concentration of NaOH was 10 wt %.

As a result, substantially no increase in the differential pressure of the submerged separation membranes was observed. The operation was stably continued at a permeation flux of 1.0 m/day for a month.

The increase in the differential pressure after the lapse of one month was 15 kPa. The mixed liquor in the biological treatment tank had the following properties.

MLSS concentration; 7200 mg/L (Fe content with respect to MLSS was 31 wt %)

MLVSS concentration; 2800 mg/L pH; 5.5

As is clear from the results, even when the amount of an iron salt added is decreased, the permeation performance of membranes can be highly maintained for a long period of time according to the present invention.

While the present invention has been described in detail and with reference to specific embodiments thereof, it will be apparent to one skilled in the art that various modifications can be made without departing from the spirit and scope of the present invention.

The present application is based on Japanese Patent Application No. 2008-158107 filed in the Japan Patent Office on Jun. 17, 2008, the entire contents of which are incorporated herein by reference.

1. A biological treatment method of organic-matter-containing water, comprising introducing raw water containing organic-matter into a biological treatment tank, mixing the raw water with activated sludge, biologically treating the raw water, and subjecting a biologically treated solution to membrane separation,
wherein an iron salt and a phenolic resin are added to the raw water or the biological treatment tank.

2. The biological treatment method of organic-matter-containing water according to claim 1, wherein an Fe amount of the iron salt added is 0.2 to 1.0 times BOD flowing into the biological treatment tank in terms of weight.

3. The biological treatment method of organic-matter-containing water according to claim 1, wherein an amount of the phenolic resin added is 1 to 500 mg/L with respect to the raw water.

4. The biological treatment method of organic-matter-containing water according to claim 1, wherein the phenolic resin has a molecular weight of 1,000 to 100,000.

5. The biological treatment method of organic-matter-containing water according to claim 1, wherein an amount of the phenolic resin added is 0.1 to 5.0 times an Fe amount of the iron salt added in terms of weight.

6. The biological treatment method of organic-matter-containing water according to claim 1, wherein the phenolic resin is added after being dissolved in an alkaline agent.

7. The biological treatment method of organic-matter-containing water according to claim 6, wherein the phenolic resin is added in a form of an alkaline aqueous solution in which a concentration of the alkaline agent is 1 to 25 wt % and a concentration of the phenolic resin is 1 to 50 wt %.

8. The biological treatment method of organic-matter-containing water according to claim 1, wherein the iron salt is at least one selected from the group consisting of ferric chloride, ferrous chloride, and polyferric sulfate.

9. The biological treatment method of organic-matter-containing water according to claim 1, wherein the phenolic resin is at least one selected from the group consisting of
a condensate between phenol and formaldehyde,
an alkyl-modified resin of a condensate between phenol and formaldehyde,
a condensate between cresol and formaldehyde,
an alkyl-modified resin of a condensate between cresol and formaldehyde,
a condensate between xylenol and formaldehyde, and
an alkyl-modified resin of a condensate between xylenol and formaldehyde.

10. The biological treatment method of organic-matter-containing water according to claim 1, wherein the phenolic resin is a novolac-type phenolic resin represented by a general formula I, 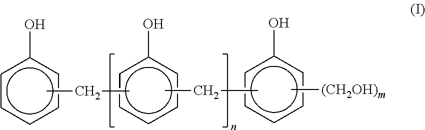
where n is 1 to 500 and m is 1 to 500.

11. The biological treatment method of organic-matter-containing water according to claim 1, wherein the phenolic resin is a resol-type phenolic resin represented by a general formula II, 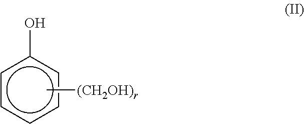
where r is 10 to 500.

12. The biological treatment method of organic-matter-containing water according to claim 1, wherein a load in the biological treatment tank is 0.5 to 5.0 kg-BOD/m³/day.

13. The biological treatment method of organic-matter-containing water according to claim 1, wherein the biologically treated solution is directly subjected to membrane separation.
